(19) United States
(12) Patent Application Publication
(10) Pub. No.: US 2007/0051545 A1
(43) Pub. Date: Mar. 8, 2007

(54) Hidden vehicle monitor

(75) Inventor: Cheng-Chi Yang, Changhua (TW)

Correspondence Address: BRUCE H. TROXELL;SUITE 1404, 5205 LEESBURG PIKE, FALLS CHURCH, VA, 22041, US

(73) Assignee: E-Lead Electronic Co., Ltd.

(21) Appl. No.: 11/205,105

(22) Filed: Aug. 17, 2005

(51) Int. Cl. B62D 31/00

(52) U.S. Cl. 180/89.1

(57) ABSTRACT

A hidden vehicle monitor installed and hidden in a trim of a vehicle includes a first member and a second member that are coupled together to form the trim. A monitor assembly is held inside the first and second members. Thus the appearance and appealing of the vehicle body remains intact while signals can be received as desired.

### BACKGROUND OF THE INVENTION

1. Field of the Invention

The invention relates to a hidden vehicle monitor and particularly to a vehicle monitor hidden in a trim to avoid damaging the appearance and appealing of the vehicle body and also receive signals.

2. Description of the Prior Art

To prevent impact on the vehicle body during driving forwards and reverse caused by blind visual spots, many schemes have been developed, such as reverse radar, vehicle distance detector, and the like. They mostly detect the distance between the vehicle body and an obstacle through optical wave or supersonic wave, and generate sound to alert the driver for the distance being detected. Thereby hitting of the vehicle body due to blind visual spot can be avoided.

While the aforesaid conventional devices can prevent hitting of the vehicle body, people's reaction on sound that alerts the distance varies. Hence the judgement of individual people differs. Moreover, even the optical or supersonic wave has blind projection spots, and cannot be as accurate as human vision. Therefore, monitor systems have been developed to provide images of the front and rear sides of the vehicle for driver reference. For the new vehicles, apertures are formed on the bumpers or the front and rear sides of the vehicles to accommodate the monitors. But to install the monitor on the existing vehicles, the bumpers or vehicle body have to be torn and altered. This damages the appearance and appealing of the vehicle body.

### SUMMARY OF THE INVENTION

In view of the aforesaid problems, the present invention aims to provide a hidden vehicle monitor that hides a monitor in a trim to avoid damaging the appearance and appealing of the vehicle body, and also facilitate installation of the monitor and receiving of pictures and signals. The invention includes a trim which consists of a first member and a second member that are coupled together. The first and second members form a housing chamber inside to hold a monitor. Then the trim is mounted onto a desired location on the front side and rear side of the vehicle to transmit the pictures in front of or on the rear side of the vehicle. By hiding the monitor in the trim which also serves ornamental purpose, damage of the vehicle body can be avoided, and picture and signal receiving functions also can be achieved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a perspective view of the invention.

FIG. 3 is a sectional view of the invention.

### DESCRIPTION OF THE PREFERRED EMBODIMENT

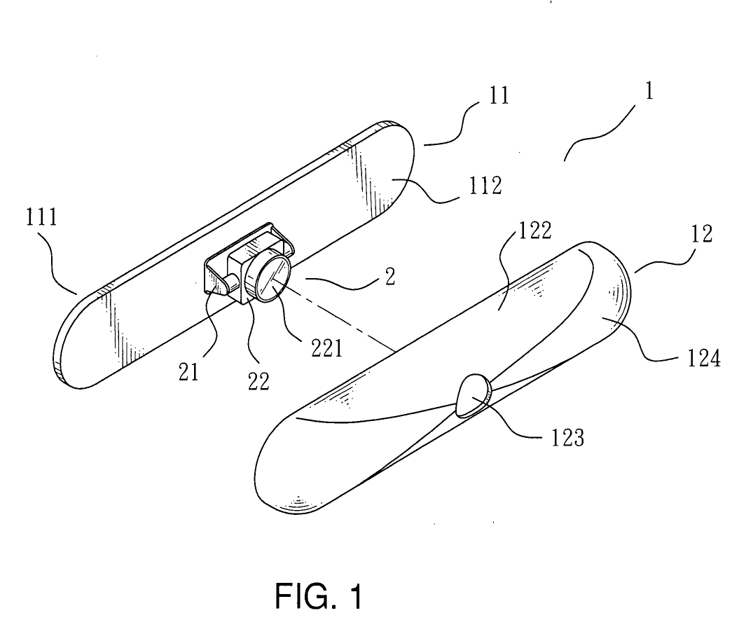

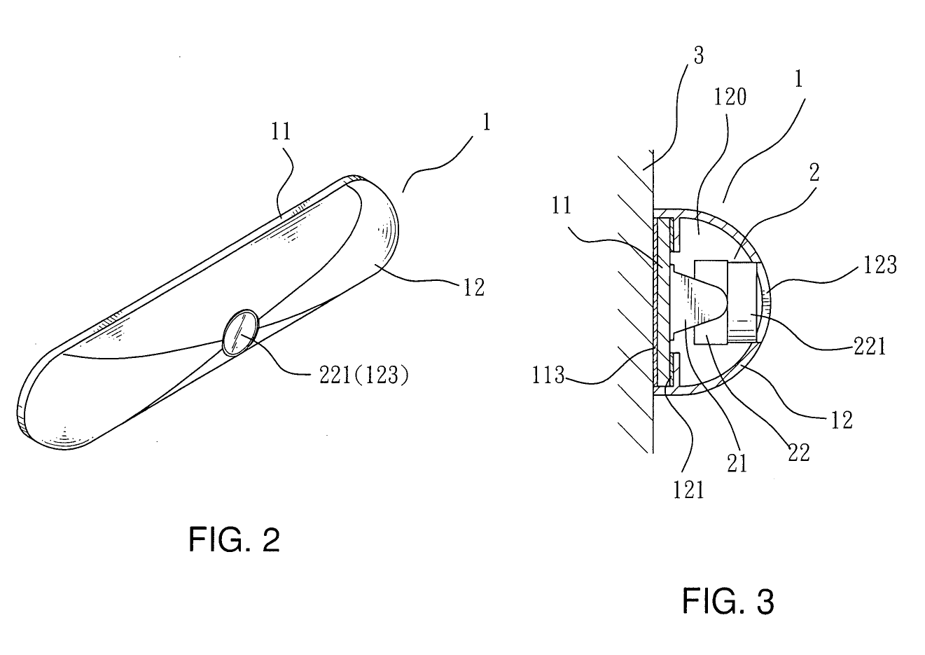

Referring to FIGS. 1, 2 and 3, the invention includes a trim 1 which consists of a first member 11 and a second member 12 to house a monitor assembly 2. The first member 11 is a flexible plate made from silicon rubber, PVC or the like. It has a first lateral surface 111 coating with adhesive 113 to be bonded to a vehicle body 3 and a second lateral surface 112 for holding the monitor assembly 2.

The second member 12 is a flexible cap to cover the first member 11, and is made from silicon rubber, PVC or the like. It has a housing chamber 120 and a bonding portion 121 to be bonded to the second lateral surface 112 of the first member 11. The second member 12 has a cap surface 122 which has one or more aperture 123 formed thereon and ornamental traces 124.

The monitor assembly 2 aims to capture images in front of the vehicle or on the rear side of the vehicle. It is mounted onto the second lateral surface 112 of the first member 11. It includes a monitor 22 hinged on a U-shaped bracket 21. The U-shaped bracket 21 has a bottom end fastened to the second lateral surface 112 of the first member 11. The monitor 22 has a lens 221 corresponding to the aperture 123 of the second member 12.

By means of the structure set forth above, for installation, first bond the adhesive 113 on the first lateral surface 111 of the first member 11 to a desired location on the vehicle body 3 (referring to FIG. 3), and calibrate the monitor assembly 2 to get a desired focusing for taking pictures; and cover the second member 12 on the first member 11, and bond the bonding portion 121 to the second lateral side 112 of the first member 11 to finish installation. The monitor assembly 2 is fully hidden in the trim 1 and does not spoil the appearance and appealing of the vehicle body. As the monitor 22 is hinged on the U-shaped bracket 21, the viewing angle of the monitor assembly 2 can be adjusted by users as desired. In addition, as the modern bumpers of vehicles are made from plastics and attached with a trim, the invention can meet the requirements of keeping the appearance intact and taking pictures.

In short, the hidden structure of the invention can avoid spoiling the appearance of vehicle body and achieve a desired signal receiving effect. It provides a significant improvement over the conventional designs.

I claim:

1. A hidden vehicle monitor comprising a first member and a second member that are coupled together to form a trim to house a monitor assembly;
wherein:
the first member is formed in a plate and has a first lateral surface coated with adhesive to be bonded to a vehicle body and a second lateral surface for holding the monitor assembly;
the second member is formed in a cap to cover the first member and has a housing chamber, the cap having a cap surface which has at least one aperture formed thereon; and
the monitor assembly is mounted onto the second lateral surface of the first member for taking pictures in front of a vehicle and on the rear side of the vehicle.

2. The hidden vehicle monitor of claim 1, wherein the cap surface of the second member has ornamental traces.

3. The hidden vehicle monitor of claim 1, wherein the first member is a flexible plate.

4. The hidden vehicle monitor of claim 3, wherein the first member is made from silicon rubber.

5. The hidden vehicle monitor of claim 3, wherein the first member is made from PVC.

6. The hidden vehicle monitor of claim 1, wherein the second member is a flexible cap.

7. The hidden vehicle monitor of claim 6, wherein the second member is made from silicon rubber.

8. The hidden vehicle monitor of claim 6, wherein the second member is made from PVC.

9. The hidden vehicle monitor of claim 1, wherein the monitor assembly includes a monitor hinged on a U-shaped bracket, the U-shaped bracket having a bottom end fastened to the second lateral surface of the first member, the monitor assembly having a lens corresponding to the aperture of the second member.

10. The hidden vehicle monitor of claim 1, wherein the second member has a bonding portion on the bottom thereof to be bonded to the second lateral surface of the first member.
